(19) United States
(12) Patent Application Publication
(10) Pub. No.: US 2004/0263325 A1
(43) Pub. Date: Dec. 30, 2004

(54) U turn indicator

(76) Inventor: Joseph Douglas Sonicola, Glendora, CA (US)

Correspondence Address: Joseph Douglas Sonicola, 1123 Saga, Glendora, CA, 91741, US

(21) Appl. No.: 10/602,842

(22) Filed: Jun. 24, 2003

(51) Int. Cl. B60Q 1/34

(52) U.S. Cl. 340/465

(57) ABSTRACT

The difference between the U turn indicators art and other art is simple. The U turn indicators art demonstrates that a U turn is taking place, by flashing, blinking, or displaying, a U turn symbol. Other art shows things like right hand turning indicators, left hand indicators, and or backing up lights. The U turn indicators art shows a blinking U in the middle of the regular car light, although that function can take many forms. No other art exhibits what our art displays, and that is a sign that a U turn is in progress. So to sum it up; our art is different because it is the only art that indicates a blinking, or flashing U for the purpose of displaying that a U turn is in progress.

### BACKGROUND

1. Field of Invention

This invention relates to the automotive industry, specifically to how a vehicle makes a “U” turn. And how the “U” turn process can be made safer on the roadways.

2. Background

Although applicant searched and searched for Prior Art none could be found

### OBJECTS AND ADVANTAGES

This invention is an ingeniously simple device unique to the auto industry. Accordingly, the “U” turn device will need to be placed on most, if not every vehicle on the road. There are many advantages for applying this new technology to as many vehicles as possible.

(A) The roadways will be safer, because everyone within a given intersection will understand that a “U” turn is about to take place.

(B) These “U” turn warning devices can be placed on any light on the vehicle, allowing for more chances to be included so that the “U” turn process will be noticed by everyone.

(C) It is an unprecedented and imaginative way to enhance the safety of the road, now and in the future.

NOTE: No prior art could be found concerning the “U” turn process. However, there is prior art showing the process on how left and right turns are completed. If requested some of those drawings will be included.

### SUMMARY

The purpose of this invention is to improve safety by warning other vehicles in the area that a “U” turn is about to be executed. The nice thing about this product is that it can easily be duplicated, as long as it depicts that a “U” turn is about to be completed. Thus, this patent covers all “U” turn devices indicating that a “U” turn is being performed. The illumination procedure includes all known current technology such as; Lamps, Light Pipes, LED'S, and Fiber Optics. In some designs it may be possible to build the “U” turn device without the outer lens standard in most vehicles.

Furthermore, this patent covers any audible signal that makes a determinable noise signaling that a “U” turn is about to take place. Please make note; that any alignment device, that is on a vehicle, that directs a drivers eye to any sign indicating that a “U” turn is about to take place is also covered under this patent.

### ART FORMS

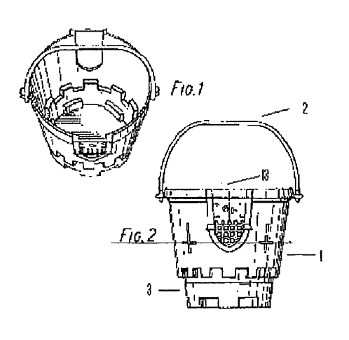

FIG. 1 is an elevation view of either the front or rear of a motor vehicle, and for reference references 3 shows the tires. The cabin, which is also shown, is a visual representation of any generic vehicle.

Drawing 1

1—Top lens

2—Bottom lens

3—Tire

4—Cabin

The lens can cover any illumination procedure including procedure including all devices known to current technology such as; LED's, Fiber Optics, Lamps, and Light Pipes. Element 1 the upper outer lens, and Element 2, the outer lower lens serve as; a protective agent, changing light cover, or multicolored prism for visual enhancement.

Drawing 2

1—Top lens (1 is showing an upper lens cover)

2—Bottom lens (2 is showing a lower lens cover)

Important note: Drawing FIG. 2 is an enlarged view of Element 1 the top lens and FIG. 2 the bottom lens. This drawing was made was made to create a reference to FIG. 3 at drawing FIG. 3.

The lens can cover any illumination producer including devices known to current technology, such as; LED's, Fiber Optic, Lamps, and Light Pipes. In some designs it may be possible to build the “U” turn device with individual illumination devices which enhance the “U” turn function without the secondary outer lens shown in drawing FIG. 1 and 2.

Drawing 3

Drawing 3 is a sectional view of elements 1 the lens showing an upper lens cover; and Element 2 the lens showing the Bottom lens cover.

1—Top lens

2—Bottom lens

5—illuminating component

6—Harness

7—energy conduit Number 5 in drawing number 3 is an element which could be illuminated through electricity, as in light bulbs or LED's, or the illumination process could be a result of a source not shown, as in the case of Fiber Optics, or light pipe. Number 6 in drawing 3 could be used for alinement, protective element, or an electronic device for LED's. Number 7 in drawing 3 could be used to deliver energy to the illuminating element.

### PREFERRED EMBODIMENT

The “U” turn signaling device can contain flashing, and or, intermittent illuminations. The source of light may be a stroboscope, incandescent lights, or LED's. In some designs it may be possible to build the “U” turn device with individual illumination apparatuses, which enhance the “U” turn function, without the secondary outer lens that come standard in most vehicles. The flashers that indicate that a “U” turn is about to take place may have many different and intermittent, recurrent and repeated illuminations, all indicating the same function; that a “U” turn is about to take place. The activation process which turns the “U” turn device, on and off, can be adapted to any technology, and be installed in any vehicle, also the entire “U” turn system can be adapted to any vehicle, as well. The “U” turn illumination procedure includes all deices known to current technologies, such as; Lamps, Light Reflectors, LED's, and Fiber Optics. Additionally, any signal, action, gesture, sign, or audible signal, used on a vehicle as means for communicating that a “U” turn is about to take place, or it is in progress, will be covered under this patent.

Lens covers can also serve several functions, one could serve as a protective agent. Another function for the lens cover could be for purpose of changing the color of the electromagnetic radiation visible to the human eye. The lens cover could also display alternate illuminating radiant flashing lights, or strobe lights, that could cause a sequentially lit up patent to flash a number of independent lights, giving the impression of movement. The lens cover could also serve as a multicolored prism for visual enhancement, so that the “U” turn procedure can clearly be seen. However, it may be possible to build the “U” turn device with individual illumination technologies which can enhance the “U” turn function, without the secondary outer lens, available on most standard vehicles.

This patent also covers any audible signal, causing vibrations sensed by the human ear, that makes a determinable noise, signaling that a “U” turn is about to take place, or is taking place, will be covered under this patent. In other words, anyone producing a device that gives the hearer the impression that a “U” turn is about to take place will be infringing on this patent. Further more any alignment device that directs a drivers eye, that comes within their field of vision, to a determining direction that indicates a sign that a “U” turn is about to take place, or that is taking place, will also be covered under this patent.

Due to changing technologies, this patent also covers any information transmitted by means of a modulated current, or an electromagnetic wave and received by any telecommunications equipment placed on a vehicle for the purpose of determining that a “U” turn is in progress, or going to begin to be in progress, will be covered in this patent. Please note that these generated signals frequencies, waves, shapes, and amplitudes can be independently adjusted over a wide range of settings.

### Operation

The “U” turn signaling device system can consist of flashing illuminating lights, and or, strobe lights. The source of light may be a Stroboscope, Incandescent Lights, Lamps, Light Pipes, LED'S, and or Fiber Optics. In some designs it may be possible to build the “U” turn device with individual illumination accessories which enhance the “U” turn function, without the secondary outer lens that come standard in most vehicles. The flashes that indicate that a “U” turn is about to take place may have many different and intermittent, recurrent and repeated illuminations.

Alternate illuminating radiant flashing lights, or strobe lights could cause a sequentially lit up patent will flash a number of independent lights, giving the impression of movement. The activation process which turns the “U” turn device, off and on, can be adapted to any technology and installed in any vehicle. The “U” turn illumination procedure includes all devices known to current technology, such as; Lamps, Light Pipes, LED'S, and Fiber Optics.

The “U” turn signaling device indicates when a “U” turn is about to take place. It can occur through a series of electromagnetism radiation which causes electromagnetic waves. Or it can simply be any indication of any symbol, on a vehicle, designating that a “U” turn is about to take place. Thus, we are patenting the process that determines when a “U” turn is about to take place.

### The Theory of Operation

This invention can change the way people drive on the road. The theory of operation is simple. Its all based on lights, wires, and electricity, that every vehicle already has in it. That is its genius. Anyone that has a basic understanding of wire, lights, and electricity, could build one. Its really simple. The genius of this product is that no one has ever made one. Accordingly, the scope of this invention should be seen in the light of insurance rates going down. Because traffic will run smother when everyone understands when a “U” turn is about to take place. It will save lives, allowing people to feel more comfortable while driving. The essence of this “U” turn device is that the roadways will be safer, and traffic will run smoother.

The nice thing about this product is that it can easily be duplicated. It can be made smaller or larger. Depending on the size of the lighting fixture on the vehicle itself. Just as long as others can see that all important “U” turn symbol. It does not even matter what type of material you use to build it. As long as it works well on your vehicle. You can make the lights in the vehicle any color. As long as it is a legal color. The lighting fixtures can be any size, as long as they fit well on the vehicle that you drive. You can even connect the wire and lighting any way you wish. Just as long as the “U” turn symbol works in some distinctive manner. The illumination procedure includes all known current technology such as; Lamps, Light Pipes, LED'S, and Fiber Optics. In some designs it may be possible to build the “U” turn device without the outer lens standard in most vehicles. The “U” turn device is so versatile that it can be built any way the builder deems, as long as it gives the indication that a “U” turn is about to take place.

Also, any audible signal that makes a determinable noise, signaling that a “U” turn is about to take place can easily be made through the use of a horn on a vehicle, as long as it is legal. Thus, even the sound signaling that a “U” turn is about to take place can be easily accomplished by anyone wishing to use a sound to announce that a “U” turn is in process.

### Conclusion, Ramifications, and Scope

The inventions main advantage is that it can easily be understood by “everyone” within any given intersection that a “U” turn is about to take place. These “U” turn warning devices can be placed on any light on the vehicle. Including, but not limited to; the front head lights, the back lights, the side reflector lights, and the right and left mirror lighting systems. It can be adopted into any shape or variation on any vehicle. Now, or in the future. Whereas, the system can contain; bulbs, sockets, wiring, flashers, switches, or any combination of electrical apparatuses built to show that a “U” turn is about to take place, will be covered under this patent.

Anyone could change the inside components and elements of this “U” turn device, and say that they have assembled a totally new product. When in reality they just packaged the same old product. Anyone can see that this “U” turn system shouldn't be limited to the particular form that is presented in here. Because the alternative physical forms that it can take are unlimited! Each type of vehicle that is made has a different look. A different size. Different lighting systems. Different color lights. Different components and elements making up each lighting system can literally take on the form of thousands, or even millions of different vehicles using the road today. As well as, tomorrow. The one unifying element however, is that document is patenting a “U” turn safety system that indicates when a “U” turn is about to take place. That means, that whoever comes up with some other method of operation designed with different components and elements somehow signaling a “U” turn, are somehow infringing on this patent. Because we are patenting the process that shows when a “U” turn is about to take place.

1-5. (canceled)

6. A bucket with a handle.

7. A handle comprising an elongated wire.

8. The handle of claim 7 further comprising a plastic grip.

9. A bucket with a blue handle.

10. The bucket of claim 9 wherein the handle is made of wood.

11. (canceled)

12. (not entered)

13. A bucket with plastic sides and bottom.
